(19) United States
(12) Patent Application Publication
(10) Pub. No.: US 2026/0253800 A1
(43) Pub. Date: Aug. 27, 2026

(54) MULTILAYER ELECTRONIC COMPONENT

(71) Applicant: SAMSUNG ELECTRO-MECHANICS CO., LTD., Suwon-si (KR)

(72) Inventors: Yong PARK, Suwon-si (KR); Kwan Soo PARK, Suwon-si (KR); Hye Yun JEONG, Suwon-si (KR); Jong Ho LEE, Suwon-si (KR); Hyun Sik CHAE, Suwon-si (KR)

(73) Assignee: SAMSUNG ELECTRO-MECHANICS CO., LTD., Suwon-si (KR)

(21) Appl. No.: 19/428,197

(22) Filed: Dec. 21, 2025

(30) Foreign Application Priority Data
Feb. 26, 2025 (KR) 10-2025-0025120

(51) Int. Cl. H01G 4/224; H01G 4/008; H01G 4/012; H01G 4/12; H01G 4/30

(52) U.S. Cl. CPC H01G 4/224; H01G 4/008; H01G 4/012; H01G 4/12; H01G 4/30

(57) ABSTRACT

A multilayer electronic component includes a body having a capacitance formation portion with dielectric layers and internal electrodes, first and second cover portions on opposite thickness surfaces, and first to sixth surfaces. Margin portions are disposed on the first, second, fifth, and sixth surfaces in a spiral arrangement. External electrodes are provided on the third and fourth surfaces.

### CROSS-REFERENCE TO RELATED APPLICATION(S)

This application claims benefit of priority to Korean Patent Application No. 10-2025-0025120 filed on February 26, 2025 in the Korean Intellectual Property Office, the disclosure of which is incorporated herein by reference in its entirety.

### TECHNICAL FIELD

The present disclosure relates to a multilayer electronic component.

### BACKGROUND ART

A multilayer ceramic capacitor (MLCC) is a chip-type condenser widely used in electronic devices. It is mounted on printed circuit boards in products such as image display devices (including liquid crystal displays (LCDs) and plasma display panels (PDPs)), computers, smartphones, and other mobile devices. An MLCC functions by storing and releasing electrical energy as needed.

MLCCs are popular because they combine small size, high capacitance, and ease of mounting. As electronic devices become increasingly compact and require higher performance, the demand for MLCCs with both miniaturization and high capacitance continues to grow.

Achieving miniaturization and high capacitance in MLCCs requires maximizing the effective electrode area, which increases the volume fraction necessary for capacitance. One common approach involves exposing internal electrodes along the width of the capacitor body through a marginless design. After forming the body and before firing, a ceramic green sheet for the margin portion is attached to the electrode-exposed surface in the width direction. The assembly is then sintered to create the margin portion.

However, as MLCCs become smaller and thinner, the dielectric layer and margin portion also thin out, making them more susceptible to moisture. Furthermore, the method of attaching a ceramic green sheet introduces an interface between the body and the margin portion that may be externally exposed. This exposed interface can act as a pathway for moisture or plating solutions, increasing the risk of short circuits and low insulation resistance (IR).

### DISCLOSURE OF INVENTION

### Technical Problem

One of many problems to be solved by the present disclosure is to provide a multilayer electronic component having excellent moisture resistance reliability.

One of many problems to be solved by the present disclosure is to provide a multilayer electronic component having reduced pores.

One of many problems to be solved by the present disclosure is to provide a multilayer electronic component having excellent toughness and bending crack resistance.

However, the many problems to be solved by the present disclosure are not limited to the above, and will be more easily understood in the process of describing specific embodiments of the present disclosure.

### Solution to Problem

A multilayer electronic component according to an embodiment of the present disclosure may comprise: a body including a capacitance formation portion including a dielectric layer and internal electrodes alternately disposed with the dielectric layer in a thickness direction, and first and second cover portions respectively disposed on both cross-sections of the capacitance formation portion in the thickness direction, first and second surfaces facing each other in the thickness direction, third and fourth surfaces connected to the first and second surfaces and facing each other in the length direction, and fifth and sixth surfaces connected to the first to fourth surfaces and facing each other in the width direction; a first margin portion disposed on the fifth surface, a second margin portion disposed on the sixth surface, a third margin portion disposed on the first surface, and a fourth margin portion disposed on the second surface; and first and second external electrodes respectively disposed on the third and fourth surfaces, and the first to fourth margin portions may be disposed in a spiral structure on the body.

### Advantageous Effects of Invention

One of many effects of the present disclosure is to improve a moisture resistance reliability of multilayer electronic components.

One of many effects of the present disclosure is to reduce pores in multilayer electronic components.

One of many effects of the present disclosure is to improve the toughness and flexural crack resistance of multilayer electronic components.

However, the various advantageous effects of the present disclosure are not limited to the above, and will be more easily understood in the process of explaining specific embodiments of the present disclosure.

### BRIEF DESCRIPTION OF DRAWINGS

FIG. 1 schematically illustrates a perspective view of a multilayer electronic component according to an embodiment of the present disclosure.

FIG. 2 schematically illustrates a cross-sectional view taken along line I-I' of FIG. 1.

FIG. 3 schematically illustrates a cross-sectional view taken along line II-II' of FIG. 1.

FIG. 4A, FIG. 4B, and FIG. 4C each schematically illustrate cross-sectional views of the same position as II-II' of FIG. 1 in multilayer electronic components according to another embodiment of the present disclosure.

FIG. 5A, FIG. 5B, and FIG. 5C each schematically illustrate enlarged views according to P1 to P3 of FIG. 3, respectively.

FIG. 6A is a moisture resistance reliability evaluation graph of a comparative example, and FIG. 6B is a moisture resistance reliability evaluation graph of an embodiment.

### DESCRIPTION OF REFERENCE CHARACTERS

Hereinafter, embodiments of the present disclosure will be described with reference to specific embodiments and the accompanying drawings. However, embodiments of the present disclosure may be modified to have various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a Z-direction may be defined as a thickness direction or a first direction, an X-direction as a length direction or a second direction, and a Y-direction as a width direction or a third direction.

Additionally, a stacking direction may be a thickness direction or a width direction.

### Multilayer Electronic Component

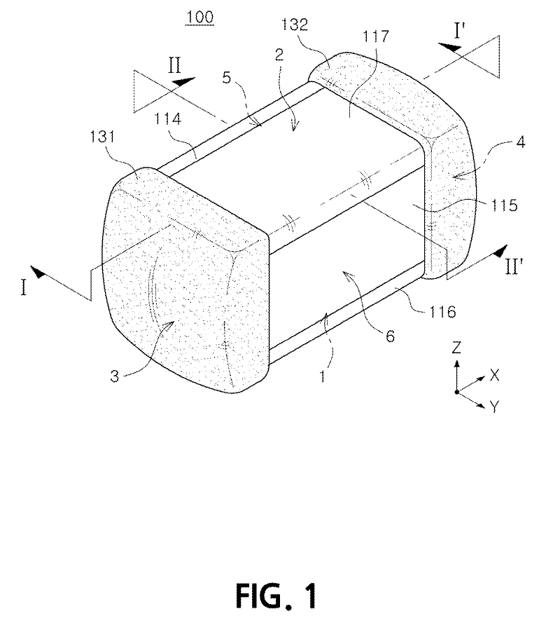

FIG. 1 schematically illustrates a perspective view of a multilayer electronic component according to an embodiment of the present disclosure.

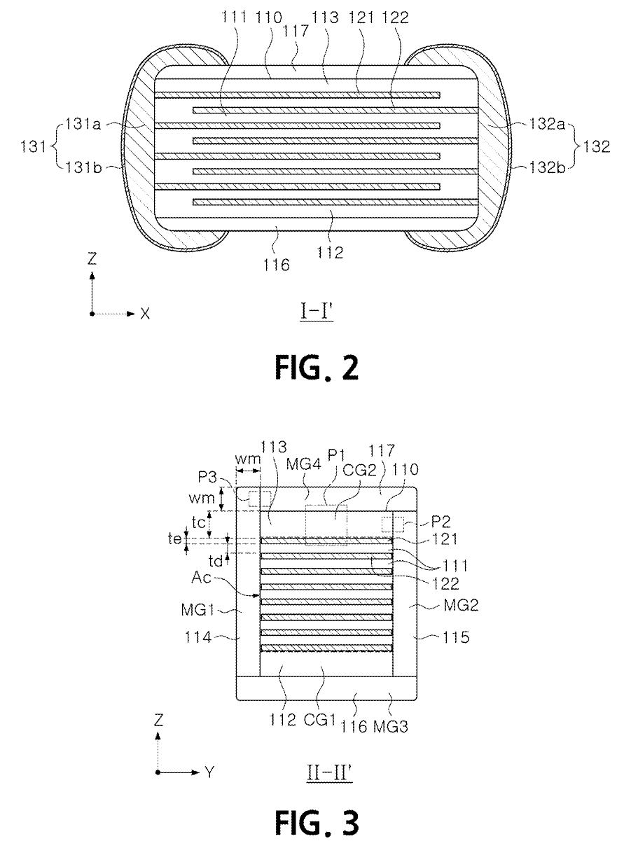

FIG. 2 schematically illustrates a cross-sectional view taken along line I-I' of FIG. 1.

FIG. 3 schematically illustrates a cross-sectional view taken along line II-II' of FIG. 1.

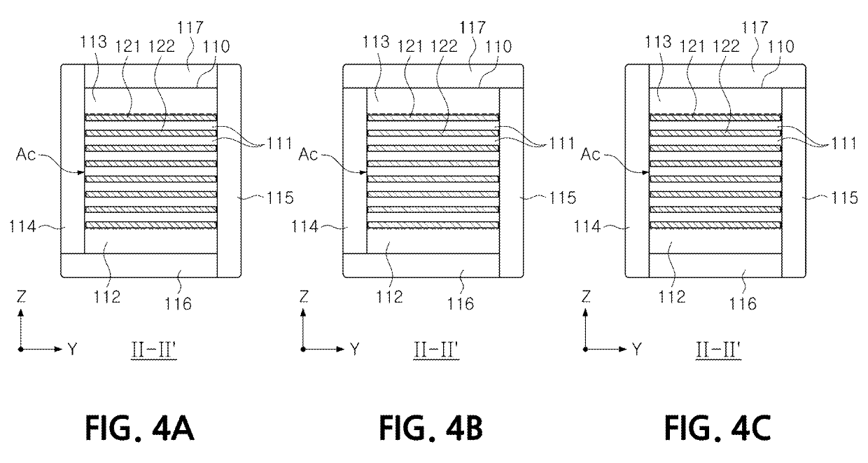

FIG. 4A, FIG. 4B, and FIG. 4C each schematically illustrate cross-sectional views of the same position as II-II' of FIG. 1 in multilayer electronic components according to another embodiment of the present disclosure.

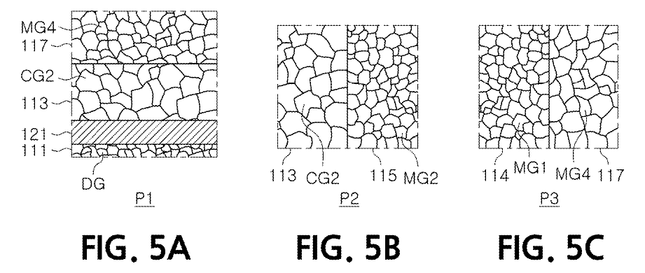

FIG. 5A, FIG. 5B, and FIG. 5C each schematically illustrate enlarged views according to P1 to P3 of FIG. 3, respectively.

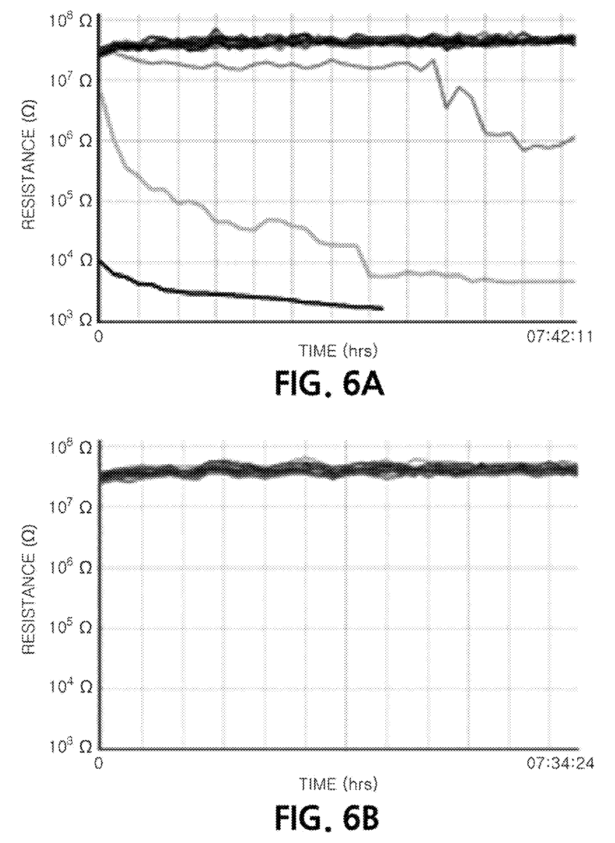

FIG. 6A is a moisture resistance reliability evaluation graph of a comparative example, and FIG. 6B is a moisture resistance reliability evaluation graph of an embodiment.

A multilayer electronic component 100 according to an embodiment of the present disclosure may comprise: a body including a capacitance formation portion Ac including a dielectric layer 111, and internal electrodes 121 and 122 alternately disposed with the dielectric layer 111 in a thickness direction, and first and second cover portions 112 and 113 respectively disposed on both cross-sections of the capacitance formation portion Ac in the thickness direction, first and second surfaces 1 and 2 facing each other in the thickness direction, third and fourth surfaces 3 and 4 connected to the first and second surfaces 1 and 2 and facing each other in the length direction, and fifth and sixth surfaces 5 and 6 connected to the first to fourth surfaces 1 to 4 and facing each other in the width direction; a first margin portion 114 disposed on the fifth surface 5, a second margin portion 115 disposed on the sixth surface 6, a third margin portion 116 disposed on the first surface 1, and a fourth margin portion 117 disposed on the second surface 2; first and second external electrodes 131 and 132 respectively disposed on the third and fourth surfaces 3 and 4, wherein the first to fourth margin portions 114, 115, 116 and 117 may be disposed in a spiral structure on the body 110.

Hereinafter, a multilayer electronic component according to an embodiment of the present disclosure will be described in detail with reference to FIG. 1, FIG. 2, FIG. 3, FIG. 4A, FIG. 4B, FIG. 4C, FIG. 5A, FIG. 5B, FIG. 5C, FIG. 6A, and FIG. 6B. However, as an example of a multilayer electronic component, a multilayer ceramic capacitor is described, but the present disclosure may also be applied to various electronic products using a dielectric composition, such as inductors, piezoelectric elements, varistors, or thermistors.

The body 110 may have a dielectric layer 111 and internal electrodes 121 and 122 alternately stacked.

More specifically, the body 110 may include a capacitance formation portion Ac forming capacitance, including a first internal electrode 121 and a second internal electrode 122 that are disposed alternately to oppose each other with a dielectric layer 111 interposed therebetween, the electrodes being disposed inside the body 110.

There is no particular limitation on the specific shape of the body 110, but as illustrated, the body 110 may have a hexahedral shape or a shape similar thereto. Due to shrinkage of the ceramic particles included in the body 110 during a sintering process, the body 110 may not have a hexahedral shape with entirely straight lines, but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

A plurality of dielectric layers 111 forming the body 110 are in a sintered state, such that boundaries between adjacent dielectric layers 111 may be integrated so as to be difficult to identify without using a scanning electron microscope (SEM).

The raw material forming the dielectric layer 111 is not limited as long as sufficient electrostatic capacitance can be obtained. In general, perovskite ABO₃-based materials may be used, for example, barium titanate-based materials, lead composite perovskite-based materials, or strontium titanate-based materials may be used. The barium titanate-based material may include BaTiO₃-based ceramic particles, and examples of the ceramic particles include BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), in which calcium Ca, zirconium Zr, or the like are partially dissolved.

In addition, the raw material for forming the dielectric layer 111 may be particles such as barium titanate BaTiO₃, to which various ceramic additives, organic solvents, binders, dispersants, or the like, may be added according to the purpose of the present disclosure.

Meanwhile, in order to distinguish a dielectric layer from the dielectric layers included in cover portions 112 and 113 and side margin portions 114, 115, 116 and 117 to be described later, the dielectric layer included in the capacitance formation portion Ac may be defined as a first dielectric layer, the dielectric layer included in the cover portions 112 and 113 may be defined as a second dielectric layer, and the dielectric layer included in the side margin portions 114, 115, 116 and 117 may be defined as a third dielectric layer.

In addition, since the first to third dielectric layers may be formed using a dielectric material such as barium titanate BaTiO₃, they may include a dielectric microstructure after sintering. The dielectric microstructure may include a plurality of grains, grain boundaries disposed between adjacent grains, and triple points disposed at points where three or more grain boundaries meet, and may respectively include a plurality of grains, grain boundaries, and triple points.

A thickness td of the dielectric layer 111 is not particularly limited.

However, in order to easily achieve miniaturization and high capacitance of the multilayer electronic component, the thickness td of the dielectric layer 111 may be 1.0 μm or less, 0.8 μm or less, or 0.6 μm or less, and in order to achieve ultra-miniaturization, it may be 0.5 μm or less, or 0.4 μm or less.

Here, the thickness td of the dielectric layer 111 may mean the thickness td of the dielectric layer 111 disposed between the first and second internal electrodes 121 and 122.

In this case, the thickness td of the dielectric layer 111 may be a concept including the thickness td of any one of a plurality of dielectric layers 111, or may be a concept including the thickness td of each of all dielectric layers 111.

In addition, the thickness td of the dielectric layer 111 may mean the average thickness td of one dielectric layer 111, may mean an average thickness td of each of the plurality of dielectric layers 111, or may mean the average thickness td of the plurality of dielectric layers 111.

The average thickness td of the dielectric layer 111 may be measured by scanning an image of a cross-section in the length and thickness direction of the body 110 using a field emission scanning electron microscope (SEM) at 10,000x magnification. More specifically, the average thickness td of one dielectric layer 111 may mean an average value calculated by measuring the thickness of one dielectric layer 111 at 5 points equally spaced apart in the longitudinal direction in a scanned image. The 5 points equally spaced apart from each other may be designated in the capacitance formation portion Ac. In addition, by extending this average value measurement to 3 dielectric layers 111 and calculate the average value, the average thickness td of the plurality of dielectric layers 111 may be further generalized.

The internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately disposed to face each other with the dielectric layer 111 constituting the body 110 interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4.

A first external electrode 131 may be disposed on the third surface 3 of the body 110 and connected to the first internal electrode 121, and a second external electrode 132 may be disposed on the fourth surface 4 of the body 110 and connected to the second internal electrode 122.

That is, the first internal electrode 121 may be connected to the first external electrode 131 without being connected to the second external electrode 132, and the second internal electrode 122 may be connected to the second external electrode 132 without being connected to the first external electrode 131. At this time, the first and second internal electrodes 121 and 122 may be electrically separated from each other by a dielectric layer 111 disposed in the middle.

Meanwhile, the body 110 may be formed by alternately laminated and fired a first ceramic green sheet printed with a paste for a first internal electrode, which will become the first internal electrode 121, and a second ceramic green sheet printed with a paste for a second internal electrode, which will become the second internal electrode 122. The printing method of the conductive paste for the internal electrode may use a screen printing method or a gravure printing method, but the present invention is not limited thereto.

The material forming the internal electrodes 121 and 122 is not particularly limited, and a material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti) and alloys thereof.

The thickness of the internal electrodes 121 and 122 do not need to be particularly limited, and the description of the thickness of the internal electrodes 121 and 122 below may mean the thickness of each of the first internal electrode 121 and the second internal electrode 122.

In order to achieve miniaturization and high capacitance of the multilayer electronic component 100, the thickness of the internal electrodes 121 and 122 may be 1.0 μm or less, 0.8 μm or less, or 0.6 μm or less, and in order to achieve ultra-miniaturization, it may be 0.5 μm or less, or 0.4 μm or less.

At this time, the thickness of the internal electrodes 121 and 122 may be a concept including the thickness of at least one of the multiple internal electrodes 121 and 122, or may be a concept including the thickness of all internal electrodes 121 and 122.

At this time, the thickness of the internal electrodes 121 and 122 may be a concept including the thickness of at least one of the plurality of internal electrodes 121 and 122, or may be a concept including the thickness of all internal electrodes 121 and 122, respectively.

In addition, the thickness of the internal electrodes 121 and 122 may mean an average thickness of one internal electrodes 121 and 122, or may mean an average thickness of each of the plurality of internal electrodes 121 and 122, or may mean an average thickness of the plurality of internal electrodes 121 and 122.

The average thickness of the internal electrodes 121 and 122 may be measured by scanning the cross-section of the body (110) in the length and thickness directions with a scanning electron microscope (SEM) at 10,000x magnification. More specifically, the average thickness of one internal electrodes 121 and 122 may be an average value calculated by measuring the thickness of one internal electrode at 5 points equally spaced apart in the longitudinal direction in the scanned image. The 5 points equally spaced apart may be designated in the capacitance formation portion Ac. In addition, extending this average value measurement to 3 internal electrodes 121 and 122, and measuring the average value, the average thickness of the plurality of internal electrodes 121 and 122 may be further generalized.

Meanwhile, the body 110 may include cover portions 112 and 113 disposed on both end-surfaces of the capacitance formation portion Ac in the thickness direction.

Specifically, the body 110 may include a first cover portion 112 disposed on one surface of the capacitance formation portion Ac in the thickness direction and a second cover portion 113 disposed on the other surface of the capacitance formation portion Ac in the thickness direction. More specifically, for example, the body 110 may include the first cover portion 112 disposed on a lower portion of the capacitance formation portion Ac in the thickness direction and a second cover portion 113 disposed on an upper portion of the capacitance formation portion Ac in the thickness direction.

In the present disclosure, the description of the cover portions 112 and 113 may be a description of the first cover portion 112 and the second cover portion 113, respectively, unless there is a special contradiction.

The first cover portion 112 and the second cover portion 113 may be formed by disposing or stacking a single second dielectric layer or two or more second dielectric layers on the upper and lower surfaces of the capacitance formation portion Ac in the thickness direction, respectively, and may prevent damage to the internal electrodes 121 and 122 due to physical or chemical stress.

The first cover portion 112 and the second cover portion 113 may not include internal electrodes 121 and 122 and may include the same dielectric material as the first dielectric layer 111 of the capacitance formation portion Ac. That is, the first cover portion 112 and the second cover portion 113 may include a dielectric material, for example, a barium titanate (BaTiO₃)-based dielectric material.

More specifically, the first and second cover portions 112 and 113 may include a main component and a secondary component of barium titanate (BaTiO₃).

The sub components included in the first and second cover portions 112 and 113 may include at least one of calcium (Ca), magnesium (Mg), silicon (Si), aluminum (Al), manganese (Mn), tin (Sn), gallium (Ga), and phosphorus (P), but are not particularly limited thereto.

In the present disclosure, the term “main component” may indicate a component occupying a relatively large weight ratio, atomic number ratio, or molar number ratio compared to other components, and may indicate a component exceeding 50 wt% or greater based on the weight of any one component of the multilayer electronic component 100, for example, the dielectric layer 111, a component exceeding 50 at% or greater based on the atomic number, or a component exceeding 50 mol% or greater based on the molar number.

In addition, in the present disclosure, the term "sub component" may indicate a component occupying a relatively small weight ratio, atomic number ratio, or molar number ratio compared to other components, and may indicate a component that is less than 50 wt% based on the weight of any one component of the multilayer electronic component 100, for example, the dielectric layer 111, a component that is less than 50 at% based on the atomic number, or a component that is less than 50 mol% based on the molar number.

In addition, as an example of a more specific method for measuring the content of an element included in a configuration of a multilayer electronic component 100 in the present disclosure, the component may be analyzed using the Energy Dispersive X-ray Spectroscopy (EDS) mode of a scanning electron microscope (SEM), the EDS mode of a transmission electron microscope (TEM), or the EDS mode of a scanning transmission electron microscope (STEM). First, a thinned sample for analysis is prepared using a focused ion beam FIB device in a region to be measured. Then, the damaged layers on the surface of the thinned sample are removed using xenon (Xe) or argon (Ar) ion milling, and thereafter, qualitative/quantitative analysis is conducted by mapping each component to be measured in the images obtained using SEM-EDS, TEM-EDS, or STEM-EDS. In this case, the qualitative/quantitative analysis of each component may be converted into the content of each element, for example, mass percentage (wt%), atomic percentage (at%), or molar percentage (mol%), and may be converted into the content of other specific components for the content of a particular component.

Another way, a region to be measured by pulverizing the chip is selected, and the specific components of the region may be analyzed using devices such as induced binding plasma spectroscopic analyzers (ICP-OES), induction binding plasma mass analyzer (ICP-MS) for parts containing the selected genome microstructure.

In the present disclosure, at least one of the first and second cover portions 112 and 113 may include a gallium (Ga), and at least one cover portions 112 and 113 may be 0.1 at% or greater at an atomic percentage of the gallium GA based on 100 at% of titanium (Ti). This may mean that each of the cover portions 112 and 113 is a titanium (Ti) 100 at%, and the atomic percentage of the gallium (Ga) is less than 0.1 at% and greater than 1 at%.

Gallium (Ga) is a low-temperature sintering agent, which may induce densification of the dielectric microstructure before grain growth is complete, thereby suppressing the creation of pores, and it may also contribute to improve moisture resistance reliability by blocking the breakdown voltage (BDV) and moisture penetration paths caused by electric field concentration.

Since the cover portions 112 and 113 satisfy the atomic percentage of gallium (Ga) of 0.1 at% or greater and 1 at% or less based on 100 at% of titanium (Ti), the sintering temperature of the cover portions 112 and 113 may be lowered to reduce the number of pores, thereby improving the density, and thereby improving the moisture resistance reliability.

If the atomic percentage of gallium (Ga) in the cover portions 112 and 113 is less than 0.1 at% based on 100 at% of titanium (Ti), the density may not be sufficiently improved, and thus the effect of improving moisture resistance reliability may be minimal. If the atomic percentage of gallium (Ga) in the cover portions 112 and 113 exceeds 1 at% based on 100 at% of titanium (Ti), the dispersibility in the dielectric slurry state prior to firing may be reduced, causing the generation of agglomerates and as a result, there is a concern that sufficient sintering density may not be secured or the firing of the cover portions 112 and 113 may not proceed sufficiently.

At least one of the first and second cover portions 112 and 113 may include phosphorus P, and at least one of the cover portions 112 and 113 may have an atomic percentage of phosphorus P of 0.1 at% or greater and 1 at% or less based on 100 at% of titanium (Ti). This may mean that each of the first cover portion 112 and the second cover portion 113 may have an atomic percentage of phosphorus P of 0.1 at% or greater and 1 at% or less based on 100 at% of titanium (Ti).

Phosphorus P may contribute in controlling grain growth and may contribute to the formation of grains of uniform size. In addition, it may suppress the creation of pores by inducing densification of the dielectric microstructure, and may improve moisture resistance reliability by blocking the breakdown voltage (BDV) and moisture penetration path caused by the electric field concentration phenomenon.

Since the cover portions 112 and 113 satisfy the atomic percentage of phosphorus P of 0.1 at% or greater and 1 at% or less based on 100 at% of titanium (Ti), it is possible to form grains of uniform size and reduce the number of pores to improve density, thereby improving mechanical strength and moisture resistance reliability.

If the atomic percentage of phosphorus P in the cover portions 112 and 113 are less than 0.1 at% based on 100 at% of titanium (Ti), it may be difficult to form grains of uniform size, which may result in a decrease in mechanical strength, or the density may not be sufficiently improved, resulting in a minimal improvement in moisture resistance reliability.

If the atomic percentage of phosphorus P in the cover portions 112 and 113 exceed 1 at% based on 100 at% of titanium (Ti), it may be difficult to form grains of uniform size due to excessive grain growth, which may result in a decrease in mechanical strength, or the dispersibility in the slurry state prior to sintering may be reduced, causing agglomerates to form, which may result in insufficient sintering density or insufficient sintering of the cover portions 112 and 113.

An average size of the plurality of grains CG1 and CG2 included in each of at least one of the first and second cover portions 112 and 113 may be 225 μm or greater and 275 μm or less.

This may mean that the average size of the plurality of grains CG1 and CG2 included in each cover portions 112 and 113 is 225 μm or greater and 275 μm or less.

Since the average size of the plurality of grains CG1 and CG2 included in each cover portions 112 and 113 is 225 μm or greater and 275 μm or less, the mechanical strength may be excellent due to the grains of an appropriate size.

The size of the crystal grains CG1 and CG2 included in each of at least one of the first and second cover portions 112 and 113 may be 200 μm or greater and 300 μm or less.

This may mean that the size of the grains CG1 and CG2 included in each cover portions 112 and 113 is 200 μm or greater and 300 μm or less.

Since the size of the grains CG1 and CG2 included in each cover portions 112 and 113 is 200 μm or greater and 300 μm or less, the mechanical strength may be excellent due to the grains of uniform size.

Meanwhile, the thickness of the cover portions 112 and 113 may not need to be particularly limited.

However, in order to easily achieve miniaturization and high capacitance of the multilayer electronic component 100, the thickness) of the cover portions 112 and 113 may be 40 μm or less, preferably 30 μm or less, and in ultra-small products, more preferably 20 μm or less.

Here, the thickness of the cover portions 112 and 113 may mean the average thickness of the cover portions 112 and 113.

Additionally, the average thickness of the cover portions 112 and 113 may mean the average thickness of each of the first and second cover portions 112 and 113, or may mean the average thickness of the first and second cover portions 112 and 113.

The average thickness of the cover portions 112 and 113 may be measured by scanning an image of a cross-section of the body 110 in the length and thickness direction using a scanning electron microscope (SEM) at 10,000x magnification. More specifically, it may mean an average value calculated by measuring the thickness at 5 points equally spaced apart in the longitudinal direction in an image scanned of one cover portions 112 and 113.

In addition, the average thickness of the cover portions 112 and 113 measured by the above-described method may have a value substantially the same as the average thickness of the cover portions 112 and 113 in the cross-section of the body 110 in the width and thickness direction.

Meanwhile, the multilayer electronic component 100 may include a margin portions 114, 115, 116 and 117, which is a region from one surface of the body 110.

More specifically, the margin portions 114, 115, 116 and 117, may include first and second margin portions 114 and 115, which are regions from a surface of the body 110 in the width direction and third and fourth margin portions 116 and 117, which are regions from a surface of the body 110 in the thickness direction, and for example, may include a first margin portion 114 disposed on the fifth surface 5, a second margin portion 115 disposed on the sixth surface 6, a third margin portion 117 disposed on the first surface 1, and a fourth margin portion 117 disposed on the second surface 2.

The margin portions 114, 115, 116 and 117 may basically contribute to prevent damage to the internal electrodes 121 and 122 due to physical or chemical stress.

The method of forming the margin portions 114, 115, 116 and 117 may be as follows, but is not particularly limited thereto. First, conductive paste is applied to the ceramic green sheet applied to the capacitance formation portion Ac to form internal electrodes 121 and 122 except for the places where the first and second margin portions 114 and 115 are to be formed, and cover portions 112 and 113 of the capacitance formation portion Ac may be formed in the thickness direction. In order to suppress a step difference caused by the internal electrodes 121 and 122, the body 110 may be cut so that the internal electrodes 121 and 122 after stacking to be exposed to the fifth and sixth surfaces 5 and 6 of the body 110, and then a single third dielectric layer or two or more third dielectric layers may be disposed or stacked in a spiral structure to surround the body 110.

More specifically, referring to FIG. 3, it may be formed by attaching and disposing or stacking the third margin portion 115, the fourth margin portion 117, the first margin portion 114, and the third margin portion 116 in that order on the body, but is not particularly limited thereto.

That is, the first to fourth margin portions 114, 115, 116 and 117 may be disposed in a spiral structure on the body 110.

Here, the meaning of the first to fourth margin portions 114, 115, 116 and 117 being disposed in a spiral structure on the body 110 may indicate that the first to fourth margin portions 114, 115, 116 and 117 are disposed on the body 110 in a clockwise or counterclockwise direction, and is not limited to the first to fourth margin portions 114, 115, 116 and 117 being disposed sequentially in a spiral structure. For example, the second margin portion 115 - the fourth margin portion 117 - the first margin portion 114 - the third margin portion 116 may be disposed in a spiral structure on the body 110, that is, the second margin portion 115 - the fourth margin portion 117 - the first margin portion 114 - the third margin portion 116 may be disposed in a clockwise direction, but is not particularly limited thereto.

At this time, the first and second margin portions 114 and 115 may be asymmetrical to each other, and the third and fourth margin portions 116 and 117 may be asymmetrical to each other.

More specifically, the average lengths of the first and second margin portions 114 and 115 in the thickness direction may be different from each other, and the average lengths of the third and fourth margin portions 116 and 117 in the width direction may be different from each other. Here, the average length in the thickness direction or the average length in the width direction may refer to the average thickness.

In addition, at least one of one end-surface of the first margin portion 114 and one end-surface of the second margin portion 115 based on one direction in the thickness direction, and the other end-surface of the first margin portion 114 and the other end-surface of the second margin portion 115 based on the other direction in the thickness direction may not be located on the width direction line. And, at least one of one end-surface of the third margin portion 116 and one end end-surface of the fourth margin portion 117 based on one direction in the width direction, and the other end-surface of the third margin portion 116 and the other end-surface of the fourth margin portion 117 based on the other direction in the width direction may not be located on a line in the thickness direction.

Here, the meaning of the cross-section or the other cross-section of the first and second margin portions 114 in the thickness direction, not being located on the width direction line, or the meaning of the cross-section or the other cross-section of the third and fourth margin portions 116 and 117 in the width direction, not being located on the thickness-direction line, is not limited to meanings that it deviates from the completely same thickness direction or width direction line. That is, in a case where one or the other surface in the thickness direction of the first margin portion 114 is not exposed externally and one or the other side in the thickness direction of the second margin portion 115 is not exposed externally, it may mean that one or the other surface corresponding to each other of the first and second margin portions 114 and 115 is not located on the width direction line. Likewise, in a case where one surface or the other surface in the width direction of the third margin portion 116 is not exposed externally and one surface or the other surface in the width direction of the fourth margin portion 117 is not exposed externally, it may mean that one surface or the other surface corresponding to each other of the third and fourth margin portions 116 and 117 is not located on the thickness direction line.

More specifically, referring to FIG. 3, the lower portion cross-section of the first margin portion 114 in the thickness direction and the lower portion cross-section of the second margin portion 115 in the thickness direction are located on substantially the same width direction line, but the upper portion cross-section of the first margin portion 114 in the thickness direction and the upper portion cross-section of the second margin portion 115 in the thickness direction are not located on substantially the same width direction line, and in this case, it may be seen that one or the other corresponding surface of the first and second margin portions 114 and 115 is not located on the width direction line.

Since the first to fourth margin portions 114, 115, 116 and 117 are disposed on the body 110 in a spiral structure, the moisture penetration path from the outside to the internal electrodes 121 and 122 may be increased, thereby preventing the internal electrodes 121 and 122 from being oxidized or shorted, thereby improving the reliability of the multilayer electronic component 100.

As in the related art, there have been various attempts to improve moisture resistance reliability by forming a margin portion by attaching a margin sheet to the side surface of the body in the width direction, as the external moisture penetration path is relatively short, however, in the case of the present disclosure, where the margin portion is disposed on the body in a spiral structure, the external moisture penetration path is relatively long, and thus moisture resistance reliability may be significantly improved by changing the structure.

The first to fourth margin portions 114, 115, 116 and 117 do not include internal electrodes 121 and 122, and may include the same material as the first dielectric layer 111. That is, the first to fourth margin portions 114, 115, 116 and 117 may include the same dielectric material as the first dielectric layer 111 of the capacitance formation portion Ac, and may include, for example, a barium titanate (BaTiO₃)-based dielectric material.

The first to fourth margin portions 114, 115, 116 and 117 may include a main component and a secondary component of barium titanate (BaTiO₃).

The sub components included in the first to fourth margin portions 116 and 117 may include at least one of calcium (Ca), magnesium (Mg), silicon (Si), aluminum (Al), manganese (Mn), tin (Sn), gallium (Ga), and phosphorus (P), but are not particularly limited thereto.

The average size of the plurality of grains MG1 and MG2 included in each of at least one of the first to fourth margin portions 114, 115, 116 and 117 may be 100 μm or greater and 150 μm or less.

This may mean that the average size of the plurality of grains MG1, MG2, MG3 and MG4 included in each margin portions 114, 115, 116 and 117 is 100 μm or greater and 150 μm or less.

By satisfying the average size of multiple grains MG1, MG2, MG3 and MG4 included in each margin portions 114, 115, 116 and 117 to be 100 μm or greater and 150 μm or less, the moisture penetration path is increased, so that moisture resistance reliability can be excellent.

The size of the grains included in each of at least one of the first to fourth margin portions 114, 115, 116 and 117 may be 75 μm or greater and 175 μm or less.

This may mean that the size of the grains MG1, MG2, MG3 and MG4 included in each margin portions 114, 115, 116 and 117 is 75 μm or greater and 175 μm or less.

By satisfying the size of the grains MG1, MG2, MG3 and MG4 included in each margin portions 114, 115, 116 and 117 to be 75 μm or greater and 175 μm or less, the grains of uniform size may have substantially no pores and increase the moisture penetration path, so that moisture resistance reliability can be excellent.

Meanwhile, a portion of the first to fourth margins 114, 115, 116 and 117 are in contact with each other, and a boundary surface may exist in the region where the margins 114, 115, 116 and 117) are in contact with each other to separate them.

For example, the first margin portion 114 and the third margin portion 116, and the first margin portion 114 and the fourth margin portion 117, are in contact, and a boundary surface that separates the first margin portion 114 and the third margin portion 116 from each other may exist in the contact region and the contact region between the first margin portion 114 and the fourth margin portion 117.

In the present disclosure, “separated” may mean that two regions are separated due to physical differences, chemical differences, and/or simple optical differences, and is not particularly limited thereto, but the separation between regions may be determined by the presence or absence of a “boundary surface.”

A boundary surface may mean a surface where two regions in contact with each other are distinguishable from each other, and may mean a state where they can be distinguished, for example, through differences in components through EDS analysis using equipment such as a scanning electron microscope (SEM), or differences in the size of grains.

To give a more specific example, the difference in average size of a plurality of grains included in one of the first to fourth margins 114, 115, 116 and 117, and another margin adjacent to one margin may be 10 μm or greater, and when the difference in average size of the plurality of grains is 10 μm or greater, the adjacent margins that are in contact are distinguished. For example, if the average size of the plurality of grains MG1 included in the first margin portion 114 is 120 μm and the average size of the plurality of grains MG3 included in the third margin portion 116 is 130 μm, the first margin portion 114 and the third margin portion 116 may be said to be distinct from each other.

To give another example more specifically, one of the first to fourth margin portions 114, 115, 116 and 117, and another margin portion adjacent to one margin portion may have a difference in atomic percentage of the same subcomponent of 0.1 at% or greater based on 100 at% of titanium (Ti), and when the difference in atomic percentage of the same subcomponent is 0.1 at% or greater, the adjacent margin portions that are in contact are distinguished. Here, the same subcomponent may mean the same single subcomponent, and the atomic percentage of the subcomponent may mean the average atomic percentage of the subcomponent measured in one margin. For example, if the first margin portion 114 includes 0.5 at% of magnesium (Mg) based on 100 at% of titanium (Ti), and the third margin portion 116 includes 0.6 at% of magnesium (Mg) based on 100 at% of titanium (Ti), the first margin portion 114 and the third margin portion 116 may be said to be distinct from each other.

In addition, one of the first and second cover portions 112 and 113, and a portion of the margin portions of the first to fourth margin portions 114, 115, 116 and 117 are in contact with each other, and a boundary surface that separates the cover portions 112 and 113, and the margin portions 114, 115, 116 and 117 may exist in the region where they are in contact.

The boundary separating the adjacent cover portion and the margin portion is the same as described above and is therefore omitted.

To give a more specific example, the average size difference of a plurality of grains included in one of the first and second cover portions 112 and 113, and one of the first to fourth margin portions 114, 115, 116 and 117 adjacent to the one cover portion may be 25 μm or greater, and when the average size difference of the plurality of grains is 25 μm or greater, it can be said that the adjacent cover portions and margin portions that are in contact are distinguished. For example, if an average size of the plurality of grains CG1 included in the first cover portion 112 is 200 μm and an average size of the plurality of grains MG1 included in the first margin portion 114 adjacent to the first cover portion 112 is 175 μm, the first cover portion 112 and the first margin portion 114 can be said to be distinct from each other.

To give another example more specifically, one of the first and second cover portions 112 and 113, and one of the first to fourth margin portions 114, 115, 116 and 117 adjacent to the one cover portion may have a difference in atomic percentage of the same subcomponent of 0.1 at% or greater based on 100 at% of titanium (Ti), and when the difference in atomic percentage of the same subcomponent is 0.1 at% or greater, the adjacent cover portion and the margin portion are distinguished from each other. For example, if the first cover portion 112 includes 0.1 at% of gallium (Ga) based on 100 at% of titanium (Ti), and the first margin portion 114 includes 0 at% of gallium (Ga) based on 100 at% of titanium (Ti) (meaning that gallium is not included), the first cover portion 112 and the first margin portion 114 are distinct from each other.

Meanwhile, a thickness of the margin portions 114, 115, 116 and 117 do not need to be particularly limited, and a description of the thickness of the margin portions 114, 115, 116 and 117 below may mean a length of each of the first margin portion 114 and the second margin portion 115 in the width direction, or a length of each of the third margin portion 116 and the fourth margin portion 117 in the thickness direction, and may mean the average thickness.

In order to easily achieve miniaturization and high capacity of the multilayer electronic component 100, the thickness of the margin portions 114, 115, 116 and 117 may be 40 μm or less, preferably 30 μm or less, and in ultra-small products, more preferably 20 μm or less.

Here, the thickness of the margin portions 114, 115, 116 and 117 may mean the average width of the margin portions 114, 115, 116 and 117.

In addition, the average thickness of the margin portions 114, 115, 116 and 117 may mean the average thickness of each of the first to fourth margin portions 114, 115, 116 and 117, or may mean the average thickness of the first to fourth margin portions 114, 115, 116 and 117.

The average thickness of the margin portions 114, 115, 116 and 117 can be measured by scanning the image of the cross-section in the width and thickness directions in the region including the margin portions 114, 115, 116 and 117 with a scanning electron microscope (SEM) at 10,000x magnification. More specifically, it may mean an average value calculated by measuring the thickness at 5 points equally spaced apart in an image scanned of one margin portion.

In an embodiment of the present disclosure, a structure in which the multilayer electronic component 100 may have two external electrodes 131 and 132 is described, but the number or shape of the external electrodes 131 and 132 may be varied depending on the form of the internal electrodes 121 and 122 or other purposes.

The external electrodes 131 and 132 may be disposed on the body 110 and may be connected to the internal electrodes 121 and 122.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and may be connected to the first internal electrode 121, and the second external electrode 132 may be disposed on the fourth surface 4 of the body and may be connected to the second internal electrode 122.

Additionally, the external electrodes 131 and 132 may extend and be disposed on portions of the first and second surfaces 1 and 2 of the body 110, or may extend and be disposed on portions of the fifth and sixth surfaces 5 and 6 of the body 110. That is, the first external electrode 131 may be disposed on the third surface 3 of the body 110 and a portion of the first, second, fifth, and sixth surfaces 1, 2, 5, and 6 of the body 110, and the second external electrode 132 may be disposed on the fourth surface 4 of the body 110 and a portion of the first, second, fifth, and sixth surfaces 1, 2, 5, and 6 of the body 110.

The external electrodes 131 and 132 may be formed of any material having electrical conductivity, such as metal, and a specific material may be determined in consideration of electrical characteristics and structural stability, or the like, and furthermore, the electrode layer may have a multilayer structure.

For example, the external electrodes 131 and 132 may include a first electrode layers 131a and 131b disposed on the body 110, and a second electrode layers 131b and 132b disposed on the first electrode layers 131a and 132a.

Here, it may be desirable for the first and second electrode layers 131a, 132a, 131b and 132b correspond to distinct layers. However, it is not particularly limited to this, and may be distinguished according to the order of the manufacturing process, and the first and second electrode layers 131a, 132a, 131b and 132b may not be distinguished from each other and may be observed as one layer.

The first electrode layers 131a and 132a may be formed by transferring a sheet including a conductive metal onto the body 110, or may be formed by applying a conductive paste for an external electrode including a conductive metal to the body 110 and then performing sintering, or may be formed by dipping the body 110 into a conductive paste for an external electrode including a conductive metal, but is not particularly limited thereto.

As a more specific example of the first electrode layers 131a and 132a, the first electrode layers 131a and 132a may be a sintered electrode including a conductive metal and glass.

A material having excellent electrical conductivity may be used as the conductive metal included in the first electrode layers 131a and 132a, and for example, the conductive metal may include one or more selected from a group consisting of nickel (Ni), copper (Cu), palladium (Pd), silver (Ag), gold (Au), platinum (Pt), tin (Sn), tungsten (W), titanium (Ti) and alloys thereof, but is not particularly limited thereto.

Additionally, the glass included in the first electrode layers 131a and 132a may improve bonding with the body 110.

The second electrode layers 131b and 132b may improve the mounting characteristics, and may be a plating layer formed on the first electrode layers 131a and 132a by plating, but is not particularly limited thereto.

The type of the second electrode layers 131b and 132b is not particularly limited, and may include, for example, at least one of nickel (Ni), tin (Sn), silver (Ag), palladium (Pd), and alloys thereof.

The second electrode layers 131b and 132b may be a single layer or may be multiple layers.

More specifically, for example, the second electrode layers 131b and 132b may be a nickel (Ni) electrode layer or a tin (Sn) electrode layer, and may be in the form of a nickel (Ni) electrode layer and a tin (Sn) electrode layer sequentially formed on the first electrode layers 131a and 132a, or may be in the form of a tin (Sn) electrode layer, a nickel (Ni) electrode layer, and a tin (Sn) electrode layer sequentially formed. Additionally, the second electrode layers 131b and 132b may include a plurality of nickel (Ni) electrode layers and/or a plurality of tin (Sn) electrode layers.

There is no need to specifically limit the size of the multilayer electronic component 100.

However, in order to achieve miniaturization and high capacitance at the same time, the thickness of the dielectric layer and internal electrodes must be reduced to increase the number of layers, so the effect of the present disclosure may be more noticeable in a multilayer electronic component 100 having a size of 1005 (length × width: 1.0 mm × 0.5 mm, length and width satisfy an error of ±10%) or less.

Additionally, the multilayer electronic component 100 may have a width greater than a length.

Hereinafter, the present disclosure will be described in more detail through test examples, but this is only to help a specific understanding of the disclosure, and the scope of the present disclosure is not limited by the test examples.

### Exam example

As a comparative example, 20 sample chips were manufactured, each having a body in which a capacitance formation portion and a cover portion of the capacitance formation portion in the thickness direction were formed as in the prior art, and a margin portion was formed on the side surface of the body in the width direction, and an external electrode was formed.

In the example, 20 sample chips were manufactured by forming a body in which a capacitance formation portion and a cover portion of the capacitance formation portion in the thickness direction are formed, and first to fourth margin portions are disposed in a spiral shape on a side surface of the body in the width direction and upper and lower surfaces in the thickness direction as in [FIG. 3], and external electrodes are formed.

FIG. 6a is a moisture resistance reliability evaluation graph of a comparative example, and FIG. 6b is a moisture resistance reliability evaluation graph of an embodiment.

When a voltage of 6.3 V was applied for 8 hours at a temperature condition of 85°C and a relative humidity condition of 85% for 20 sample chips of comparative examples and examples, the sample chips whose insulation resistance IR fell below 10⁶ Ω based on the initial insulation resistance IR₀ of 10⁸ Ω were determined to be defective in moisture resistance reliability.

In the comparative example, 3 sample chips were defective, whereas in the examples, no sample chips were observed to be defective.

From this, it may be confirmed that the moisture resistance reliability is improved when four margin portions are disposed spirally on the outside of the body.

Although the embodiments or test examples of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including a capacitance formation portion including a dielectric layer and internal electrodes alternately disposed with the dielectric layer in a thickness direction, and first and second cover portions respectively disposed on both surfaces of the capacitance formation portion in the thickness direction, first and second surfaces facing each other in the thickness direction, third and fourth surfaces connected to the first and second surfaces and facing each other in a second direction, and fifth and sixth surfaces connected to the first to fourth surfaces and facing each other in a width direction;
a first margin portion disposed on the fifth surface, a second margin portion disposed on the sixth surface, a third margin portion disposed on the first surface, and a fourth margin portion disposed on the second surface; and
the first and second external electrodes respectively disposed on the third and fourth surfaces,
wherein the first to fourth margin portions are disposed in a spiral structure on the body.

2. The multilayer electronic component of claim 1, wherein the first and second margin portions are asymmetrical to each other, and the third and fourth margin portions are asymmetrical to each other.

3. The multilayer electronic component of claim 1, wherein the average lengths of the first and second margin portions in the thickness direction are different from each other,
wherein the average lengths of the third and fourth margin portions in the width direction are different from each other.

4. The multilayer electronic component of claim 1, wherein at least one of one cross-section of the first margin portion and one cross-section of the second margin portion based on one direction of the thickness direction, and the other cross-section of the first margin portion and the other cross-section of the second margin portion based on the other direction of the thickness direction, is not disposed on a line in the width direction,
wherein at least one of one cross-section of the third margin portion and one cross-section of the fourth margin portion based on one direction of the width direction, and the other cross-section of the third margin portion and the other cross-section of the fourth margin portion based on the other direction of the width direction, is not disposed on a line in the thickness direction.

5. The multilayer electronic component of claim 1, wherein a portion of the first to fourth margin portions are in contact with each other, and a boundary surface exists between the margin portions in the contact regions.

6. The multilayer electronic component of claim 1, wherein the first to fourth margin portions include a plurality of grains,
wherein an average size difference of the plurality of grains included in one of the first to fourth margin portions and each of the other margin portions adjacent to the one margin portion is 10 μm or greater.

7. The multilayer electronic component of claim 1, wherein the first to fourth margin portions include a plurality of grains,
wherein an average size of the plurality of grains included in each of at least one of the first to fourth margin portions is 100 μm or greater and 150 μm or less.

8. The multilayer electronic component of claim 1, wherein the first to fourth margin portions include a plurality of grains,
wherein the size of the grains included in each of at least one of the first to fourth margin portions is 75 μm or greater and 175 μm or less.

9. The multilayer electronic component of claim 1, wherein the first to fourth margin portions include a subcomponent including at least one of calcium (Ca), magnesium (Mg), silicon (Si), aluminum (Al), manganese (Mn), tin (Sn), gallium (Ga), and phosphorus (P), and titanium (Ti),
wherein one of the first to fourth margin portions and another margin portion adjacent to the one margin portion have a difference in atomic percentage of the same component of 0.1 at% or more based on 100 at% of titanium (Ti).

10. The multilayer electronic component of claim 1, wherein the average thickness of each of at least one of the first to fourth margin portions is 40 μm or less.

11. The multilayer electronic component of claim 1, wherein the first and second cover portions include a plurality of grains,
wherein an average size of the plurality of grains included in each of at least one of the first and second cover portions is 225 μm or greater and 275 μm or less.

12. The multilayer electronic component of claim 1, wherein the first and second cover portions include a plurality of grains,
wherein the size of the grains included in each of at least one of the first and second cover portions is 200 μm or greater and 300 μm or less.

13. The multilayer electronic component of claim 1, wherein at least one of the first and second cover portions comprises titanium (Ti) and gallium (Ga),
wherein at least one of the cover portions has an atomic percentage of gallium (Ga) of 0.1 at% or greater and 1 at% or less based on 100 at% of titanium (Ti).

14. The multilayer electronic component of claim 1, wherein at least one of the first and second cover portions comprises titanium (Ti) and phosphorus (P),
wherein at least one of the cover portions has an atomic percentage of phosphorus (P) of 0.1 at% or greater and 1 at% or less based on 100 at% of titanium (Ti).

15. The multilayer electronic component of claim 1, wherein the average thickness of each of at least one of the first and second cover portions is 40 μm or less.

16. The multilayer electronic component of claim 1, wherein one of the first and second cover portions and a portion of the first to fourth margin portions are in contact with each other, and a boundary surface exists between the regions where the cover portion and the margin portion are in contact with each other.

17. The multilayer electronic component of claim 1, wherein the first and second cover portions and the first to fourth margin portions include a plurality of grains,
wherein an average size difference of the plurality of grains included in one of the first and second cover portions and one of the first to fourth margin portions adjacent to the one cover portion is 25 μm or greater.

18. The multilayer electronic component of claim 1, wherein the first and second cover portions and the first to fourth margin portions include a plurality of grains,
wherein an average size of the plurality of grains included in each of at least one of the first and second cover portions is 225 μm or greater and 275 μm or less,
wherein an average size of the plurality of grains included in each of at least one of the first to fourth margin portions is 100 μm or greater and 150 μm or less.

19. The multilayer electronic component of claim 1, wherein the first and second cover portions and the first to fourth margin portions include a plurality of grains,
wherein the size of the grains included in each of at least one of the first and second cover portions is 200 μm or greater and 300 μm or less,
wherein the size of the grains included in each of at least one of the first to fourth margin portions is 75 μm or greater and 175 μm or less.

20. The multilayer electronic component of claim 1, wherein the first and second cover portions and the first to fourth margin portions include a subcomponent including at least one of calcium (Ca), magnesium (Mg), silicon (Si), aluminum (Al), manganese (Mn), tin (Sn), gallium (Ga), and phosphorus (P), and titanium (Ti),
wherein one of the first and second cover portions and one of the first to fourth margin portions adjacent to the one cover portion have a difference in atomic percentage of the same component of 0.1 at% or greater based on 100 at% of titanium (Ti).
